(19) United States
(12) Patent Application Publication
(10) Pub. No.: US 2026/0260579 A1
(43) Pub. Date: Sep. 3, 2026

(54) SYSTEM

(71) Applicant: SOFTBANK GROUP CORP., Tokyo (JP)

(72) Inventor: Takuya NAGAI, Tokyo (JP)

(73) Assignee: SOFTBANK GROUP CORP., Tokyo (JP)

(21) Appl. No.: 19/554,723

(22) Filed: Mar. 3, 2026

Related U.S. Application Data
(60) Provisional application No. 63/766,200, filed on Mar. 3, 2025.

(51) Int. Cl. G09B 21/00; G06V 10/82; G06V 40/20; G10L 15/26; G10L 21/10

(52) U.S. Cl. CPC G09B 21/009; G06V 10/82; G06V 40/28; G10L 15/26; G10L 21/10

(57) ABSTRACT

A sign language conversion system for facilitating communication between individuals using different sign languages or cultures, or between deaf individuals and hearing individuals. This system uses a high-resolution camera and motion sensor mounted on a terminal to capture sign language motions in real time and transmit them to a server. The server analyzes the motion data using a deep learning algorithm to recognize the sign language. The recognized sign language is converted by a conversion unit into sign language of a different language or into text, and is visually provided to the user on the terminal's display unit. This enables real-time communication between individuals using different sign languages or between deaf individuals and hearing individuals, thereby promoting social inclusion.

### CROSS-REFERENCE TO RELATED APPLICATION

This application claims priority under 35 U.S.C. § 119 to U.S. Provisional Patent Application No. 63/766,200, filed on March 3, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

Removing communication barriers between deaf individuals using different sign languages or cultures, or between deaf individuals and hearing individuals is a modern technology issue. Specifically, since sign language varies by country and region, there exists the problem that individuals using different sign languages find it difficult to communicate directly. Furthermore, between deaf individuals and hearing individuals, communication often does not proceed smoothly because many hearing individuals cannot understand sign language. These challenges are aimed to be solved by using generative AI technology to analyze sign language motions in real time and convert them into different sign languages or text. This enables deaf individuals to communicate smoothly with people worldwide, promoting social inclusion. Furthermore, providing a crucial technological foundation to contribute to the international Sustainable Development Goals (SDGs).

To solve these challenges, a system comprising: a capture unit that captures sign language motions in real time; an analysis unit that analyzes the captured motion data to recognize sign language; a conversion unit that converts the recognized sign language into sign language of a different language or text; and a display unit that displays the converted sign language or text is provided.

This system first acquires multidimensional information, such as the hand movements, position, shape, and speed of the signer, via the capture unit. Next, the analysis unit uses deep learning algorithms to analyze the acquired motion data and recognize with high accuracy which sign language it corresponds to. The recognized sign language is then converted by the conversion unit into sign language of a different language or into text. This conversion adapts the sign language to different cultures and languages while preserving its meaning. Finally, the display unit shows the converted sign language or text, enabling users to visually confirm it. This facilitates smooth communication between individuals using different sign languages and between deaf and hearing individuals.

### BRIEF DESCRIPTION OF THE DRAWINGS

FIG. 1 is a conceptual diagram showing an example configuration of the data processing system according to the first embodiment.

FIG. 2 is a conceptual diagram showing an example of the main functional components of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiment, the communication I/F (Interface) is an interface including a communication processor and an antenna, etc. The communication I/F governs communication between multiple computers. An example of a communication standard applied to the communication I/F is 5G (5th Generation Mobile Communication System), Wi-Fi (registered trademark), or Bluetooth (registered trademark), among others.

In the following embodiments, "A and/or B" is synonymous with "at least one of A and B." That is, "A and/or B" may mean A alone, B alone, or a combination of A and B. Furthermore, in this specification, when three or more items are expressed using "and/or," the same concept applies as for "A and/or B".

### First Embodiment

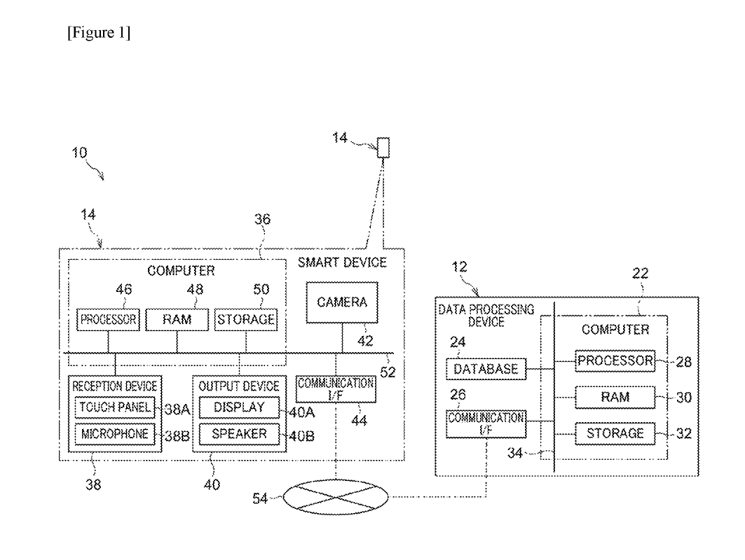

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. are connected to a bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

The output device 40 includes a display 40A and a speaker 40B, among others. It presents data to the user 20 by outputting it in a form perceptible to the user 20 (e.g., voice and/or text). The display 40A displays visual information such as text and images according to instructions from the processor 46. The speaker 40B outputs voice according to instructions from the processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

Communication I/F 44 is connected to network 54. Communication I/Fs 44 and 26 handle the exchange of various information between processor 46 and processor 28 via network 54.

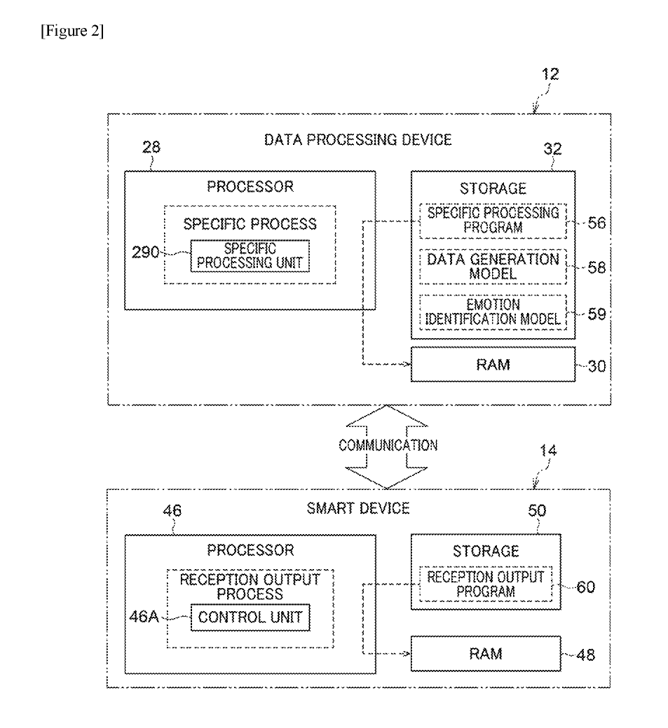

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. Processor 28 reads specific processing program 56 from storage 32 and executes the read specific processing program 56 on RAM 30. The specific processing is realized by processor 28 operating as specific processing unit 290 according to specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention will now be described in further detail. This sign language conversion system realizes a series of processes—capturing, analyzing, converting, and displaying sign language motions in real time—through the collaboration of the server and the terminal.

First, the terminal is equipped with a high-resolution camera and a high-precision motion sensor. These devices function as a capture unit to capture the user's sign language movements in real time. The camera can capture detailed hand shapes and movements, while the motion sensor precisely measures hand position, movement speed, and direction. This enables the acquisition of sign language motion data as multidimensional information. This data is temporarily processed within the terminal and transmitted to the server as a digital signal.

The server side houses an analysis unit equipped with a powerful processor and large-capacity memory. The server receives the motion data transmitted from the terminal and performs analysis using deep learning algorithms. This analysis unit has been pre-trained on millions of sign language data points, enabling it to recognize with high accuracy which sign language the input motion corresponds to. Specifically, technologies such as convolutional neural networks (CNN) and recurrent neural networks (RNN) are employed to identify hand shapes and movement patterns.

The analyzed sign language is converted into sign language or text of a different language within the server's conversion unit. This conversion unit adapts the sign language to different cultures and languages while preserving its meaning. For example, when converting Japanese Sign Language to International Sign Language, the server maps Japanese Sign Language motions to International Sign Language motions. This mapping utilizes natural language processing (NLP) technology to understand the context and meaning of the sign language and perform appropriate conversions.

The converted data is sent back to the terminal and visually presented to the user via the terminal's display unit. The terminal displays the converted sign language or text on a high-resolution display, allowing the user to view it. For example, when a deaf person communicates with a hearing person, the hearing person's speech is converted to text using speech recognition technology, and that text is then converted to sign language and displayed on the deaf person's screen. Conversely, the deaf person's sign language is converted into text and displayed on the hearing person's screen. This process occurs in real time, ensuring communication proceeds smoothly without interruption.

Furthermore, the system employs data encryption technology to protect user privacy. Communication between terminals and servers uses secure protocols to prevent data leaks and unauthorized access. The system also provides a customizable interface to enhance user convenience, allowing users to modify display settings according to their preferences.

In this way, the coordinated operation of the server and terminal enables smooth communication between individuals using different sign languages and between deaf individuals and hearing individuals. This system aims to remove barriers for deaf individuals communicating with people worldwide and contribute to the realization of a more inclusive society.

### System Configuration

The system according to this embodiment comprises a capture unit, an analysis unit, a conversion unit, a display unit, and a communication unit. The capture unit captures the hand movements of a sign language user in real time and includes a high-resolution camera and a high-precision motion sensor. For example, the camera can capture detailed hand shapes and movements, while the motion sensor precisely measures hand position, movement speed, and direction. This capture unit acquires sign language motion data as multidimensional information and transmits it as a digital signal to a server.

The analysis unit is located on the server side. It receives the motion data transmitted from the terminal and performs analysis using a deep learning algorithm. The analysis unit has been pre-trained on millions of sign language data points, enabling it to recognize with high accuracy which sign language the input motion corresponds to. Specifically, technologies such as convolutional neural networks and recurrent neural networks are used to identify hand shapes and movement patterns. For example, even when sign language movements are fast, the analysis unit can accurately track them and recognize them as appropriate signs. Furthermore, the analysis unit possesses the capability to accurately analyze sign language movements under varying lighting conditions.

The conversion unit is responsible for converting the analyzed sign language into sign language or text of a different language. The conversion unit adapts the sign language meaning to different cultures and languages while preserving its meaning. For example, when converting Japanese Sign Language to International Sign Language, the conversion unit maps Japanese Sign Language motions to International Sign Language motions. This mapping utilizes natural language processing technology to understand the context and meaning of the sign language and perform appropriate conversions. Furthermore, when converting sign language to text, the conversion unit can generate natural sentences while maintaining grammatical accuracy.

The display unit visually provides converted sign language and text to the user. The terminal displays the converted sign language and text on a high-resolution display so the user can see it. For example, when a deaf person communicates with a hearing person, the hearing person's speech is converted to text using speech recognition technology, and that text is converted to sign language and displayed on the deaf person's screen. Additionally, the deaf person's sign language is converted into text and displayed on the hearing person's screen. This process occurs in real time, enabling communication to proceed smoothly without interruption.

The communication unit handles data transmission and reception between the terminal and the server, employing data encryption technology. Communication between the terminal and the server uses a secure protocol to prevent data leakage and unauthorized access. For example, the communication unit uses the latest encryption algorithms to protect user privacy and ensure data security. Furthermore, the communication unit optimizes data transmission and reception speeds to enable real-time communication.

Specific examples of prompt sentences to be fed into the generative AI required for implementing the present invention include: "Analyze sign language movements and convert Japanese Sign Language to International Sign Language," "Capture and analyze sign language motion data in real time," and "Convert sign language from different languages into text and display it." These prompt sentences function as instructions for the generative AI to accurately perform sign language analysis and conversion.

### Implementation Steps

### Step 1: Capturing Sign Language Motion

In this step, the device's high-resolution camera and high-precision motion sensor capture the user's sign language movements in real time. The camera captures detailed hand shapes and movements, while the motion sensor precisely measures hand position, movement speed, and direction. This acquires sign language motion data as multidimensional information. This data is temporarily processed within the device and transmitted to the server as a digital signal.

### Step 2: Motion Data Analysis

The analysis unit located on the server receives the motion data transmitted from the device and analyzes it using a deep learning algorithm. The analysis unit has been pre-trained on millions of sign language data points and accurately recognizes which sign corresponds to the input motion. Specifically, it analyzes the hand shape and movement using deep learning algorithms. The analysis unit has been pre-trained on millions of sign language data points, enabling it to recognize with high accuracy which sign language the input motion corresponds to. Specifically, techniques such as convolutional and recurrent neural networks to identify hand shapes and movement patterns.

### Step 3: Sign Language Conversion

The analyzed sign language is converted into sign language or text of a different language within the server's conversion unit. The conversion unit adapts the sign language to different cultures and languages while preserving its meaning. For example, when converting Japanese Sign Language to International Sign Language, the conversion unit maps Japanese Sign Language motions to International Sign Language motions. This mapping utilizes natural language processing technology to understand the context and meaning of the sign language and perform appropriate conversions. A specific example of a prompt sentence fed to the generative AI is "Analyze sign language movements and convert Japanese Sign Language to International Sign Language."

### Step 4: Displaying the Converted Data

The converted data is sent back to the terminal and visually presented to the user on the terminal's display. The terminal displays the converted sign language and text on a high-resolution display for the user to confirm. For example, when a deaf person communicates with a hearing person, the hearing person's speech is converted to text using speech recognition technology, and that text is converted to sign language and displayed on the deaf person's screen. Conversely, the deaf person's sign language is converted to text and displayed on the hearing person's screen.

### Step 5: Data Communication

The communication unit handles data transmission and reception between the terminal and the server, employing data encryption technology. Communication between the terminal and the server uses a secure protocol to prevent data leakage and unauthorized access. For example, the communication unit uses the latest encryption algorithms to protect user privacy and ensure data security. Furthermore, the communication unit optimizes data transmission and reception speeds to enable real-time communication.

### Specific Use Cases

For example, consider a scenario where a deaf person participates in an international conference. This conference brings together participants from multiple countries, where different languages and sign languages are used. When the deaf person speaks using Japanese Sign Language, the device's capture unit captures the sign language motions in real time. A high-resolution camera and motion sensors precisely capture the hand's movements, shape, position, and speed, transmitting this motion data to the server.

The server's analysis unit uses a deep learning algorithm to analyze this motion data and recognize which sign language it corresponds to. The analysis unit identifies the sign language movements with high accuracy based on pre-trained sign language data. The analyzed sign language is converted into international sign language by the conversion unit. The conversion unit utilizes natural language processing technology to adapt the sign language to different languages while preserving its meaning.

The converted International Sign Language is transmitted to other participants' terminals and visually presented on the display unit. Participants can view the converted sign language on high-resolution displays and understand the content of the deaf person's statements. Conversely, when a hearing person speaks, speech recognition technology is used to convert the speech into text. This text is then converted into Japanese Sign Language and displayed on the deaf person's terminal. This process occurs in real time, ensuring uninterrupted and smooth communication throughout the meeting.

Specific examples of prompt sentences to be fed into the generative AI required for implementing the present invention include: "Analyze Japanese Sign Language motion data and convert it to International Sign Language," "Transcribe audio data into text and convert it to Japanese Sign Language," and "Capture and analyze sign language movements in real time." These prompt sentences function as instructions for the generative AI to accurately perform sign language analysis and conversion.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

A more specific and detailed description of an embodiment for implementing the present invention is provided below. This embodiment is a sign language conversion system designed to facilitate communication between hearing-impaired elderly residents, staff, and other users within a care facility. This system comprises a capture unit, an analysis unit, a conversion unit, a display unit, and a communication unit.

First, the capture unit will be described in detail. The capture unit is installed in terminals placed in each room and common area within the care facility. The terminals include a high-resolution camera and a high-precision motion sensor. These devices capture the user's sign language movements in real time. For example, when a user communicates meal preferences via sign language, the camera captures detailed hand shapes and movements, while the motion sensor precisely measures hand position, movement speed, and direction. This acquires sign language motion data as multidimensional information. This data is temporarily processed within the terminal and transmitted as a digital signal to a server within the facility. Furthermore, the capture unit is equipped with dynamic adjustment capabilities to adapt to varying lighting conditions and user movement speeds, ensuring optimal capture at all times.

Next, the analysis unit is described in detail. The analysis unit is located on the facility's server and receives motion data transmitted from the terminal. The server analyzes this motion data using deep learning algorithms to recognize which sign language it corresponds to. The analysis unit identifies sign language movements with high precision based on a pre-trained database of millions of sign language entries. For example, if a user signs "Please give me water," the server analyzes the movements and generates the corresponding text. The analysis unit possesses the capability to perform accurate analysis regardless of varying lighting conditions or the speed of the user's movements. Furthermore, the analysis unit is equipped with advanced algorithms that understand the context of the sign language and select the most appropriate sign from among similar movements.

The conversion unit is responsible for converting the analyzed sign language into sign language or text in a different language. The conversion unit utilizes natural language processing technology to adapt the sign language meaning to different cultures and languages while preserving its essence. For example, when converting Japanese Sign Language to English text, the conversion unit analyzes the Japanese Sign Language motions and generates natural sentences based on English grammar. During this process, it comprehends the sign language's context and meaning to perform appropriate conversions. The conversion unit supports multiple languages and can convert to various languages according to user needs.

The display unit visually presents the converted sign language or text to the user. The terminal displays the converted sign language or text on a high-resolution display, allowing users and staff to confirm it. For example, a display in a cafeteria might show the text "Please give me water," enabling staff to confirm it and respond promptly. Additionally, when staff wish to communicate something to a user, they can use speech recognition technology to convert their spoken words into text. This text can then be converted into sign language and displayed on the user's terminal. The display unit features a customizable user interface, allowing font size and color to be adjusted according to the user's visual needs.

Finally, the communication unit will be explained in detail. The communication unit handles the transmission and reception of data between the terminal and the server, employing data encryption technology. Communication between the terminal and the server is conducted using the CURE protocol, preventing data leakage and unauthorized access. For example, the communication unit uses the latest encryption algorithms to protect user privacy and ensure data security. Furthermore, the communication unit employs the CURE protocol to prevent data leakage and unauthorized access. For example, the communication unit uses the latest encryption algorithms to protect user privacy and ensure data security. To protect user privacy, the communication unit employs the latest encryption algorithms to ensure data security. It also optimizes data transmission speeds to enable real-time communication. The communication unit dynamically switches communication protocols based on network conditions, consistently providing the optimal communication environment.

Thus, the embodiments of the present invention facilitate communication within care facilities and provide an environment where elderly individuals with hearing impairments can live more comfortably. Furthermore, it is expected to reduce the burden on staff and improve the overall operational efficiency of the facility. Specific examples of prompt sentences to feed into the generative AI include: "Analyze sign language movements and convert them to text," and "Convert audio data to text and then convert it to sign language." These prompt sentences function as instructions for the generative AI to accurately perform sign language analysis and conversion.

### SYSTEM CONFIGURATION

The system according to this embodiment comprises a capture unit, an analysis unit, a conversion unit, a display unit, and a communication unit. The capture unit is installed on terminals placed in each room and common space within the care facility and includes a high-resolution camera and a high-precision motion sensor. The capture unit is designed to capture sign language movements performed by users in real time. For example, when a user communicates meal preferences via sign language, the camera captures detailed hand shapes and movements, while the motion sensor precisely measures hand position, movement speed, and direction. This acquires sign language motion data as multidimensional information. Furthermore, the capture unit incorporates dynamic adjustment capabilities to adapt to varying lighting conditions and user movement speeds, ensuring optimal capture at all times.

The analysis unit is located on a server within the facility and receives motion data transmitted from the terminal. The analysis unit uses deep learning algorithms to analyze this motion data and recognize which sign language it corresponds to. Based on a pre-trained sign language database containing millions of entries, the analysis unit identifies sign language movements with high precision. For example, if a user signs "Please give me water," the server analyzes the motion and generates the corresponding text. The analysis unit possesses the capability to perform accurate analysis regardless of varying lighting conditions or the speed of the user's movements. Furthermore, the analysis unit incorporates advanced algorithms to understand the context of the sign language and select the most appropriate sign from among similar motions.

The conversion unit converts the analyzed sign language into sign language or text in different languages. The conversion unit utilizes natural language processing technology to adapt the sign language meaning to different cultures and languages while preserving its essence. For example, when converting Japanese Sign Language to English text, the conversion unit analyzes the Japanese Sign Language motions and generates natural sentences based on English grammar. During this process, it comprehends the sign language's context and meaning to perform appropriate conversions. The conversion unit supports multiple languages and can convert to various languages according to user needs.

The display unit visually presents the converted sign language or text to the user. The terminal displays the converted sign language or text on a high-resolution display, allowing users and staff to confirm it. For example, a display in a cafeteria might show the text "Please give me water," enabling staff to confirm it and respond promptly. Additionally, when staff wish to communicate something to a user, they can use speech recognition technology to convert their speech into text, then convert that text into sign language for display on the user's terminal. The display unit features a customizable user interface, allowing font size and color to be adjusted according to the user's visual needs.

The communication unit handles data transmission between the terminal and the server, employing data encryption technology. Communication between the terminal and server uses secure protocols to prevent data leakage and unauthorized access. For example, the communication unit uses the latest encryption algorithms to protect user privacy and ensure data security. It also optimizes data transmission speeds to enable real-time communication. The communication unit is equipped with the capability to dynamically switch communication protocols based on network conditions, consistently providing the optimal communication environment.

Thus, the system according to this embodiment facilitates communication within care facilities and provides an environment where elderly individuals with hearing impairments can live more comfortably. It is also expected to reduce staff burden and improve the overall operational efficiency of the facility. Specific examples of prompt sentences fed to the generative AI include "Analyze sign language movements and convert them to text" and "Convert audio data to text and then convert it to sign language." These prompt sentences function as instructions for the generative AI to accurately perform sign language analysis and conversion.

### Implementation Steps

### Step 1: Capturing Sign Language Motions

In this step, high-resolution cameras and high-precision motion sensors installed on terminals placed in each room and common area within the care facility capture the user's sign language movements in real time. The cameras capture detailed hand shapes and movements, while the motion sensors precisely measure hand position, movement speed, and direction. This acquires sign language motion data as multidimensional information. This data is temporarily processed within the terminal and transmitted as a digital signal to the facility's server. The capture unit features dynamic adjustment capabilities to adapt to varying lighting conditions and user movement speeds, ensuring optimal capture at all times.

### Step 2: Motion Data Analysis

The analysis unit, located on the server, receives the motion data transmitted from the terminal and analyzes it using deep learning algorithms. The analysis unit identifies sign language movements with high precision based on a pre-trained database of millions of sign language examples. For instance, if a user signs "Please give me water," the server analyzes the movement and generates the corresponding text. The analysis unit possesses the capability to perform accurate analysis regardless of varying lighting conditions or the speed of the user's movements. Furthermore, the analysis unit is equipped with advanced algorithms that understand the context of sign language and select the most appropriate sign from among similar movements.

### Step 3: Sign Language Conversion

The analyzed sign language is converted into sign language or text in different languages by the conversion unit. The conversion unit utilizes natural language processing technology to adapt the sign language meaning to different cultures and languages while preserving its meaning. For example, when converting Japanese Sign Language into English text, the conversion unit analyzes the Japanese Sign Language motions and generates natural sentences based on English grammar. In this process, it understands the context and meaning of the sign language to perform appropriate conversion. The conversion unit supports multiple languages and can convert to various languages according to user needs. A specific example of a prompt sentence fed to the generative AI is "Analyze sign language movements and convert them to text."

### Step 4: Displaying Conversion Data

The converted sign language and text are visually presented to the user via the display unit. The terminal displays the converted sign language and text on a high-resolution display, allowing users and staff to confirm it. For example, a cafeteria display might show the text "Please give me water," allowing staff to confirm and respond promptly. Additionally, when staff wish to communicate something to a user, they can use speech recognition technology to convert their speech into text, then convert that text into sign language and display it on the user's terminal. The display unit features a customizable user interface, allowing font size and color to be adjusted according to the user's visual needs.

### Step 5: Data Communication

The communication unit handles data transmission between terminals and servers, employing data encryption technology. Communication between terminals and servers uses secure protocols to prevent data leaks and unauthorized access. For example, the communication unit uses the latest encryption algorithms to protect user privacy and ensure data security. It also optimizes data transmission speeds to enable real-time communication. The communication unit dynamically switches communication protocols based on network conditions, consistently providing the optimal communication environment.

### Specific Use Cases

For example, in a nursing facility, the present invention's sign language conversion system is introduced to support communication for elderly residents with hearing impairments during daily life. This facility envisions a scenario where a resident orders food in the cafeteria. When the resident signs "Please give me water," the capture unit captures the sign language movements in real time. The high-resolution camera captures detailed hand shape and movement, while the motion sensor precisely measures hand position, movement speed, and direction. This acquires the sign language motion data as multidimensional information and transmits it to the server.

The analysis unit located on the server analyzes the motion data using a deep learning algorithm to recognize which sign language it corresponds to. The analysis unit identifies the sign language movements with high precision based on a pre-trained sign language database. The analyzed sign language is converted into text by the conversion unit. The conversion unit utilizes natural language processing technology to understand the context and meaning of the sign language while preserving its meaning, thereby generating appropriate text.

The converted text is displayed on the cafeteria's display. For example, the text "Please give me water" is displayed, allowing staff to confirm it and respond promptly. Additionally, when staff wish to convey something to a user, they can use speech recognition technology to convert their speech into text, then convert that text into sign language and display it on the user's terminal. This enables smooth communication between hearing-impaired elderly individuals and staff.

Specific examples of prompt sentences to be fed into the generative AI required for implementing the present invention include: Examples include "analyzing sign language movements and converting them to text" and "transcribing audio data into text and converting it to sign language." These prompt sentences function as instructions for the generative AI to accurately analyze and convert sign language. This system facilitates smoother communication within care facilities, providing an environment where elderly individuals with hearing impairments can live more comfortably.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio indicating user input acquired by the microphone 38B to the data processing device 12. The data processing device 12 acquires the audio data from the specific processing unit 290.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. and can perform various processing tasks, but are not limited to these examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

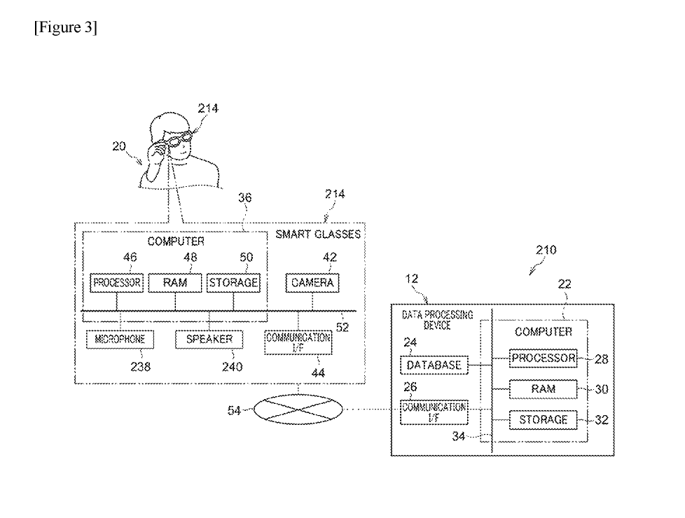

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

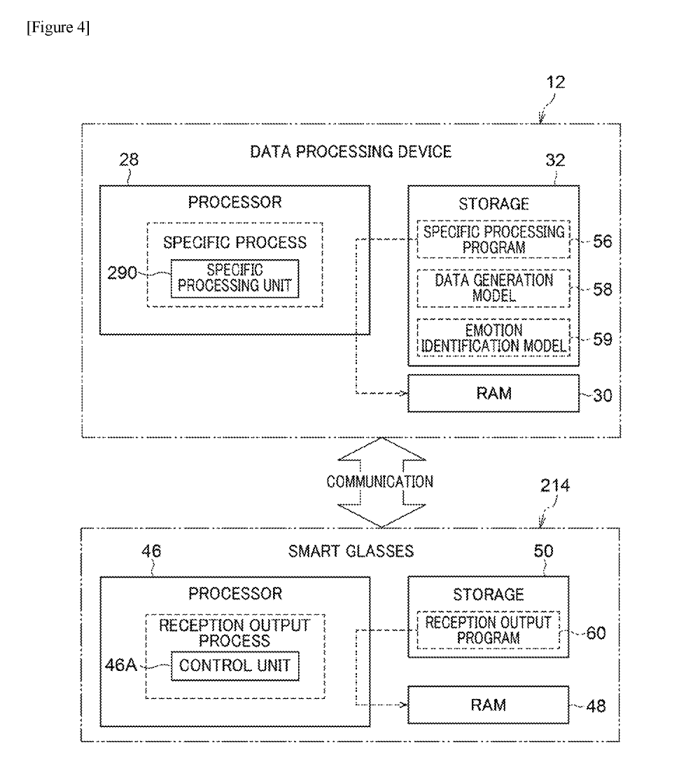

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. Processor 28 reads the specific processing program 56 from storage 32 and executes the read specific processing program 56 on RAM 30. The specific processing is realized by processor 28 operating as a specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing is the same as that described in Example 1 of the first embodiment, so the explanation is omitted.

### Application Example 1

The flow of the specific processing in Example 1 described in the first embodiment is the same as above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input prompts containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

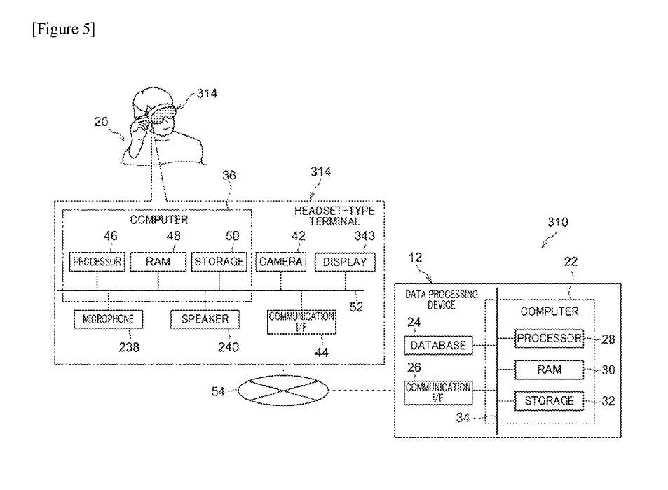

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

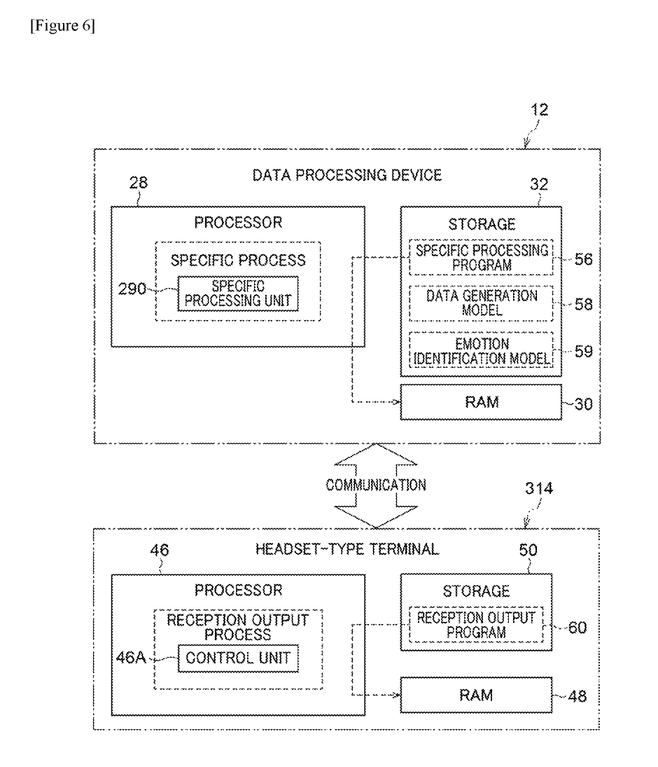

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. The processor 46 reads the reception output program 60 from the storage 50 and executes the read reception output program 60 on the RAM 48. Reception output processing is realized by the processor 46 operating as a control unit 46A according to the reception output program 60 executed on the RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### Fourth Embodiment

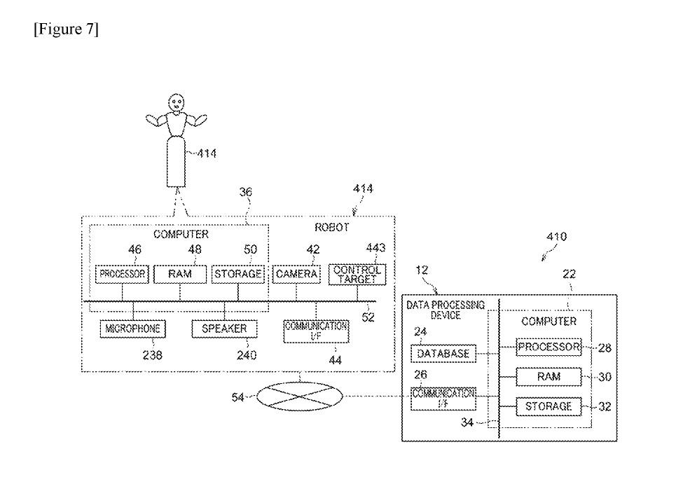

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

The microphone 238 receives voice output from the user 20, thereby accepting instructions and the like from the user 20. The microphone 238 captures the voice output from the user 20 and converts the captured audio into audio data, which it outputs to the processor 46. The speaker 240 outputs audio in accordance with instructions from the processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

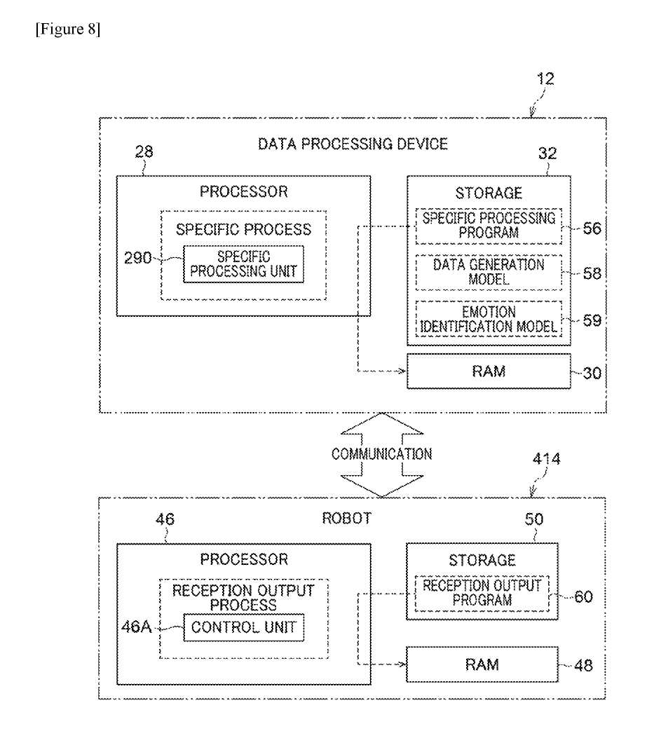

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are realized by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

Application Example 1

The flow of the specific processing in Example 1 described in the first embodiment is the same as above, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as input of inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit may acquire step count data using the camera 42 or communication I/F 44 of the smart device 14, and this data is processed by the specific processing unit 290 of the data processing device 12. For example, the analysis unit may be realized by the specific processing unit 290 of the data processing device 12, and it analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

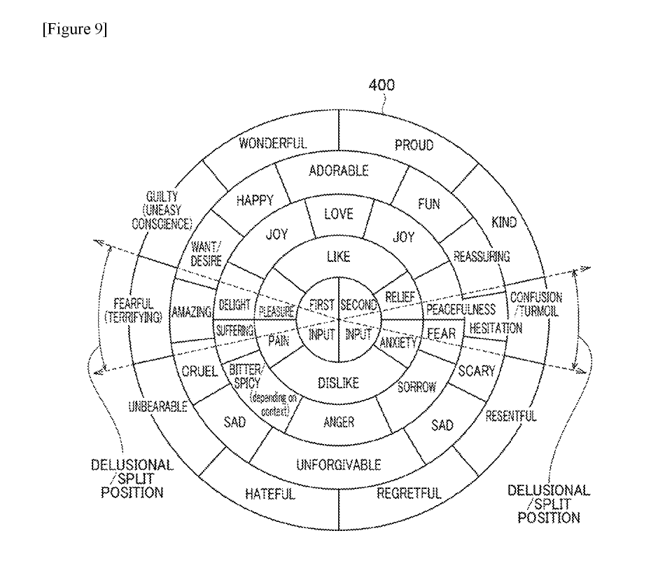

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged in concentric circles radiating from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed on the upper and lower sides of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped closer together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Based on research on speech emotion recognition and brain physiological signal analysis systems for emotions, Tokushima University, Doctoral Dissertation: https://ci.nii.ac.jp/naid/500000375379). The left half of the emotion map displays emotions belonging to the "Reaction" domain, where sensory aspects predominate. The right half of the emotion map displays emotions belonging to the "Situation" domain, where situational awareness is dominant.

Two emotions that promote learning are defined in the emotion map. One is the negative emotion around the center of the "repentance" or "reflection" area on the situation side. That is, when the robot experiences negative emotions like "I never want to feel this way again" or "I don't want to be scolded anymore." The other is the positive emotion around "Desire" on the reaction side. That is, when the robot feels positive emotions like "I want more" or "I want to know more."

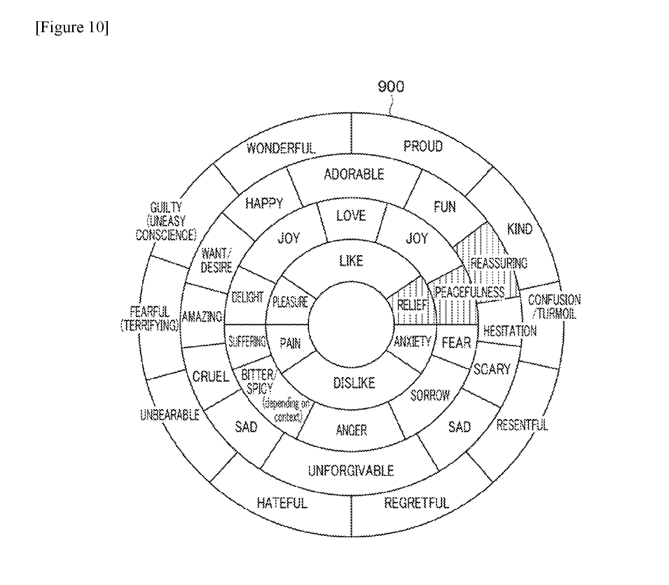

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "confidence," have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone or similar device. The method of the present disclosure may be provided to users in a SaaS (Software as a Service) format.

The above embodiments illustrated a configuration where specific processing is performed by a single computer 22. However, the technology of this disclosure is not limited thereto. Distributed processing may be performed by multiple computers, including computer 22, for specific processing. For example, data generation model 58 may be provided in an external device of data processing device 12, and said external device may generate data corresponding to input data. For example, the data generation model 58 may be provided in an external device of the data processing device 12, and data generation corresponding to input data may be performed in said external device.

The above embodiment described a configuration where the specific processing program 56 is stored in the storage 32. However, the technology disclosed herein is not limited to this. For example, the specific processing program 56 may be stored on a portable, computer-readable non-volatile storage medium, such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 on a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., programs. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing specific processing. Second, there is a form using a processor that implements the entire system's functionality, including multiple hardware resources executing specific processing, on a single IC chip, as exemplified by a System-on-a-chip (SoC). Thus, specific processing is implemented using one or more of the above various processors as hardware resources.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects of the part pertaining to the technology of this disclosure. Therefore, it goes without saying that within the scope not deviating from the main purpose of the technology of this disclosure, unnecessary parts may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure have been omitted from the above descriptions and illustrations.

All literature, patent applications, and technical specifications cited herein are incorporated by reference to the same extent as if each were specifically and individually cited.

The following further details are disclosed regarding the above embodiments.

### Supplementary note 1

A system comprising a capture unit, an analysis unit, a conversion unit, a display unit, and a communication unit. The capture unit captures the hand movements of a sign language user in real time and includes a high-resolution camera and a high-precision motion sensor. The analysis unit is located on the server side, receives motion data transmitted from the terminal, and performs analysis using a deep learning algorithm. The conversion unit converts the analyzed sign language into sign language of a different language or text, utilizing natural language processing technology. The display unit visually provides the converted sign language or text to the user, and the communication unit transmits and receives data between the terminal and the server.

### Supplementary note 2

The system according to Supplementary note 1, wherein the capture unit comprises a high-resolution camera for capturing detailed hand shapes and movements, and a motion sensor for measuring hand position, movement speed, and direction with high precision, and wherein the analysis unit has been pre-trained on millions of sign language data points, enabling it to recognize with high accuracy which sign language the input motion corresponds to.

### Supplementary note 3

The system described in Supplementary note 1, wherein the conversion unit utilizes natural language processing technology to adapt sign language meaning to different cultures and languages while preserving its meaning, and the display unit displays the converted sign language and text on a high-resolution display for the user to confirm.

### Explanation of Symbols

10, 210, 310, 410 Data Processing System

12 Data Processing Device

14 Smart Device

214 Smart Glasses

314 Headset-type devices

414 Robot

What is claimed is:

1. A system for real-time sign language conversion, comprising:
a terminal device including at least one imaging sensor configured to capture hand shape and motion of a user performing sign language, and
at least one motion sensor configured to acquire multidimensional motion data including hand position, movement speed, and direction;
a server device including one or more processors and a memory storing program instructions that, when executed by the one or more processors, cause the server device to receive the multidimensional motion data transmitted from the terminal device;
analyze the received motion data using a trained deep learning model to recognize an input sign language expression;
convert the recognized sign language expression into an output in a different sign language or a text representation; and
a display unit configured to output the converted sign language or text to at least one user in real time,
wherein the system enables bidirectional communication between users employing different sign languages or between a deaf user and a hearing user by performing sign language recognition and conversion with reduced latency compared to manual interpretation.

2. The system of claim 1, wherein the capture unit comprises the high-resolution camera and the high-precision motion sensor for capturing detailed hand shapes, positions, movement speed, and direction as multidimensional motion data in real time.

3. The system of claim 1, wherein the analysis unit employs deep learning algorithms including a convolutional neural network (CNN) and a recurrent neural network (RNN) to identify hand shape features and motion patterns for sign language recognition.

4. The system of claim 1, wherein the conversion unit is configured to translate the recognized sign language expression from a first sign language into a second sign language of a different language, by mapping the sign language motions of the first sign language to corresponding motions of the second sign language using natural language processing to preserve context and meaning.

5. The system of claim 1, wherein the analysis unit utilizes context-aware processing to disambiguate similar sign language motions and select an appropriate sign based on contextual meaning, thereby improving recognition accuracy for signs that are otherwise ambiguous.

6. The system of claim 1, further comprising a microphone and a speech recognition module configured to convert spoken words from a hearing individual into text, and wherein the conversion unit is further configured to convert the text into a corresponding sign language expression for display on the display unit via a customizable user interface, thereby facilitating smooth communication between the hearing individual and a hearing-impaired elderly user in a care facility environment.

7. A computer-implemented method for real-time sign language conversion, the method comprising:
capturing, by a terminal device, sign language motions of a user using at least one camera and at least one motion sensor to generate multidimensional motion data including hand shape, position, movement speed, and direction;
transmitting the multidimensional motion data from the terminal device to a server device via a communication network;
analyzing, by one or more processors of the server device, the multidimensional motion data using a trained deep learning model to extract spatial and temporal features corresponding to an input sign language expression;
converting the recognized input sign language expression into an output in a different sign language or into a text representation while preserving semantic meaning; and
displaying the output sign language or text on a display device in synchronization with the captured sign language motions,
wherein all of the steps are executed continuously to enable real-time communication between users using different sign languages.

8. The method of claim 7, wherein capturing the sign language motions includes using a high-resolution video camera and a high-precision motion sensor to collect detailed hand shape, position, and movement information as multidimensional data in real time.

9. The method of claim 7, wherein analyzing the motion data comprises applying a deep learning recognition model that includes a convolutional neural network (CNN) to extract spatial features of the hand movements and a recurrent neural network (RNN) to analyze temporal sequences of the sign language motions.

10. The method of claim 7, wherein converting the recognized sign language expression includes translating the expression from a first sign language into a second sign language of a different region or standard, such that an input in Japanese Sign Language is converted into an output in International Sign Language while preserving the original meaning.

11. The method of claim 7, wherein the analyzing step further utilizes contextual information to improve accuracy by disambiguating similar signs, including accounting for variations in signer speed and ambient lighting conditions during recognition.

12. The method of claim 7, further comprising capturing an audio input from a user via a microphone, converting the audio input into text using speech recognition, and converting the text into a corresponding sign language output on the display device, to enable communication from a hearing user to a deaf or hearing-impaired user in real time.

13. A non-transitory computer-readable storage medium storing instructions that, when executed by one or more processors of a computing system, cause the computing system to perform operations comprising:
acquiring multidimensional sign language motion data captured by an imaging sensor and a motion sensor, the motion data including spatial and temporal hand movement information;
processing the motion data using a trained deep learning recognition model to generate a recognized sign language representation;
converting the recognized sign language representation into an output representation selected from a different sign language representation or a text representation using a language conversion model; and
generating display control data for presenting the output representation on a display device in real time,
wherein execution of the instructions reduces computational latency of sign language recognition and conversion relative to a rule-based sign language translation process.

14. The computer-readable medium of claim 13, wherein the instructions for capturing the sign language motions cause the computing system to utilize a high-resolution camera and a motion sensor to capture detailed hand movement data as multidimensional information in real time.

15. The computer-readable medium of claim 13, wherein the instructions for analyzing the motion data include instructions to apply a deep learning-based sign language recognition model comprising a convolutional neural network and a recurrent neural network, the model being configured to identify handshape features and motion patterns of the sign language from the motion data.

16. The computer-readable medium of claim 13, wherein the instructions for converting the recognized sign language expression include instructions to translate the sign language expression from a first sign language into a second sign language different from the first, by mapping an input in Japanese Sign Language to an output in International Sign Language while preserving context and meaning using natural language processing.

17. The computer-readable medium of claim 13, wherein the instructions further cause the computing system to present the converted output on a user interface that is customizable according to user preferences, allowing the user to adjust one or more display settings selected from font size and color for improved visibility.

18. The computer-readable medium of claim 13, wherein the instructions further include instructions to transmit the motion data and the converted output via a secure, encrypted communication channel between a user-side device and a server, thereby protecting user privacy and ensuring low-latency, real-time performance of the sign language conversion system.
